(19) United States
(12) Patent Application Publication
(10) Pub. No.: US 2017/0122380 A1
(43) Pub. Date: May 4, 2017

(54) A RATCHET APPARATUS

(71) Applicant: SHANGHAI EASY-USE TOOLS ENTERPRISE CO., LTD., Shanghai (CN)

(72) Inventor: Shiyu Sun, Shanghai (CN)

(21) Appl. No.: 15/102,411

(22) PCT Filed: Jul. 24, 2015
(86) PCT No.: PCT/CN2015/085112

§ 371 Date: Jun. 7, 2016

(30) Foreign Application Priority Data
Apr. 22, 2015 (CN) 201510198845.0

(51) Int. Cl. F16D 7/04

(52) U.S. Cl. CPC F16D 7/048

(57) ABSTRACT

The present invention relates to a ratchet comprising a fluted disc, wherein the fluted disc is set with the cooperating ratchet base; wherein the ratchet base is fixedly connected to the said fluted disc through the lock screw; wherein said ratchet upper cover is set with reversing part, and wherein the reversing part is provided with mating cards; wherein a fixed reversing shift is located between the said reversing part and the said cards; wherein one of the reversing part is also set with reversing gear that cooperate with the said reversing shift; wherein the ratchet also comprises two dental sclerite within the cards, wherein it sets the mating spring parts among the said dental sclerite.

### TECHNICAL FIELD

The present invention relates to a ratchet.

### BACKGROUND

Presently, ratchet has been applied in the mechanical field. However, conventional ratchets do not have the function of shifting. Most ratchet have only one function. Conventional ratchet often requires additional ratchet when ratcheting is needed in multiple locations.

Therefore, developing a ratchet with shift function has become an urgent problem within the industry.

### SUMMARY OF INVENTION

The purpose of the present invention is to provide a ratchet to overcome the above-described deficiencies of the existing technology. The purpose of the present invention is achieved by the following technical solutions:

A kind of ratchet that includes a fluted disc. The foresaid fluted disc is set with the cooperating ratchet base. The ratchet base is fixedly connected to the said fluted disc through the lock screw. The said ratchet upper cover is set with reversing part, and the reversing part is provided with cooperating cards. And there is a fixed reversing shift between the said reversing part and the said cards. One said of the reversing part is also set with reversing gear that cooperate with the said reversing shift. What is more, it also has set two dental sclerites within the cooperating cards, and it has set the mating spring parts among the said dental sclerite.

Further, the said ratchet is connected to the said fluted disc by threaded connection.

Further, the said lock screw is connected to the said fluted disc by threaded connection.

Further, the said reversing shift is fixed between the said card member and reversing part by reversing shift sleeve.

The beneficial effects of the present invention is as follows: by setting the reversing part, it can play a role in regulating ratchet gear. The auxiliary adjustment of dental sclerite can better achieve the shift effect of ratchet adjustment. In addition, this model is more convenient, has more utility, and include a variety of functions.

### BRIEF DESCRIPTION OF THE FIGURES

Further features and advantages of the present device, as well as the structure and operation of various embodiments of the present device, will become apparent and more readily appreciated from the following description of the preferred embodiments, taken in conjunction with the accompanying drawings of which.

FIG. 1 is an exploded view of a ratchet according to the implementation of present invention.

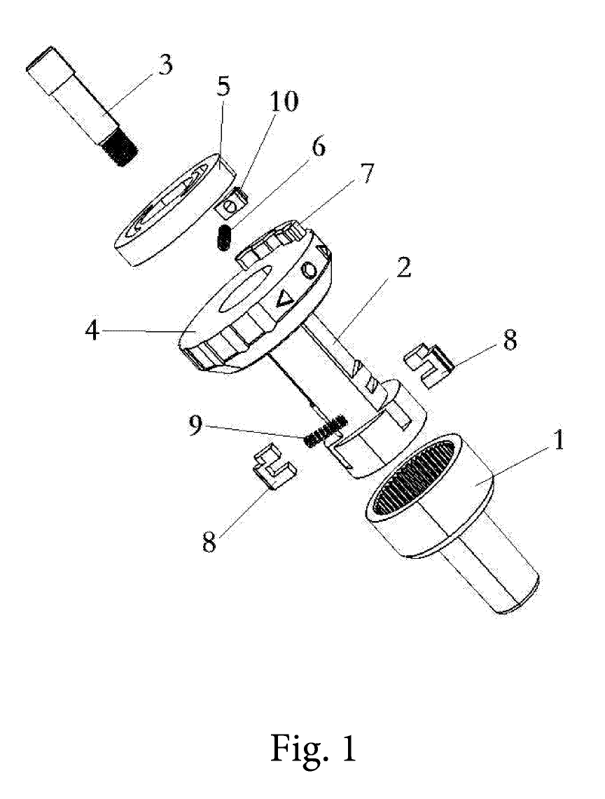

In the FIGURE

1. Fluted disc; 2 Ratchet base; 3 Lock screws; 4. Reversing part; 5. Cooperating cards; 6. Reversing shift; 7 Reversing gear; 8. Dental sclerites; 9. Spring parts; 10. Reversing shift sleeve.

### DETAILED DESCRIPTION

In the following detailed description, reference is made to the accompanying drawings that form a part hereof, and in which is shown by way of illustration specific implementations that may be practiced. These implementations are described in sufficient detail to enable those skilled in the art to practice the implementations, and it is to be understood that other implementations may be utilized and that logical, mechanical, electrical and other changes may be made without departing from the scope of the implementation.

The following detailed description is, therefore, not to be taken in a limiting sense. A type of ratchet that implemented according to this invention, it comprises fluted disc (1), said fluted disc (1) is set with cooperating ratchet base (2), wherein the said ratchet base (2) is fixedly connected to fluted disc (1) by lock screw (3); wherein the upper cover of said ratchet base (2) corresponds to the reversing part (4), wherein the reversing part (4) corresponds to the cooperating cards (5), said reversing part (4) and the said cards is fixedly connected by a reversing shift (6); wherein one side of the reversing part (4) comprise a reversing gear (7) that cooperate with the said reversing shift (6); wherein said cooperating card (5) also corresponds to two dental sclerites (8), and wherein a mating spring parts (9) is disposed between the dental sclerite(8).

In one embodiment, the said ratchet base (2) is connected to the said fluted disc (1) by threaded connection.

In another embodiment, the said lock screw (3) is connected to the said fluted disc (1) by threaded connection.

In another embodiment, the said reversing shift (6) is fixed between the said cooperating card (5) and the reversing part (4) by reversing shift sleeve (10).

According to the above technical proposal, adjustment of ratchet shift function can be achieved by the reversing part 4. Specifically, when the reversing shift 6 is on the right, the left dental sclerite 8 together rotates with card 5. When the reversing shift 6 is rotated to the middle, both the left and right dental sclerites 8 cooperate with card 5, and the gear is placed in a locked state. Finally, when the reversing shift 6 is rotated to the left, the right dental sclerite cooperates with card 5. In this invention, the dental sclerite 8 provides assistance to making adjustments, and the said spring part 9 is disposed between the two dental sclerites 8, and it serves the role of shift function by stirring reversing part 4

By using the above technical proposal of this invention, it can play a role in regulating ratchet gear by the setting reversing part. And the auxiliary adjustment of dental sclerite can better realize the shift effect of ratchet adjustment. In addition, this model also has features of convenience and utility, variety and multiple functions.

The foregoing is only preferred embodiments of the present invention, it is not intended to limit the present invention. Any modifications, equivalent replacement or improvement within the spirit and principles of the present invention should be included in the scope of protection of the present invention.

1. A ratchet comprising:
a fluted disc (1), wherein the said fluted disc (1) corresponds with a cooperating ratchet base (2), wherein the ratchet base (2) is fixedly connected to fluted disc (1) by lock screw (3); wherein said the upper cover of the ratchet base (2) corresponds with a reversing part (4), wherein the said reversing part (4) corresponds with cooperating cards (5), wherein the reversing part (4) and the cards is connected by a reversing shift (6); wherein one side of the reversing part (4) corresponds to a reversing gear (7) that cooperates with the reversing shift (6); wherein said card (5) is correspond with two dental sclerites (8), and wherein a mating spring parts (9) is disposed between said the two dental sclerites (8).

2. The ratchet, according to claim 1, wherein said ratchet base (2) is connected to the said fluted disc (1) by threaded connection.

3. The ratchet, according to claim 1, wherein the lock screw (3) is connected to the said fluted disc (1) by threaded connection.

4. The ratchet, according to claim 1, wherein the said reversing shift (6) is fixed between said the operating card (5) and the reversing part (4) by reversing shift sleeve (10).
